(19) United States
(12) Patent Application Publication
(10) Pub. No.: US 2008/0078918 A1
(43) Pub. Date: Apr. 3, 2008

(54) VIBRATION DAMPING DEVICES FOR FUEL PUMPS

(75) Inventors: Takuhito FUJIWARA, Obu-shi (JP); Takayuki USUI, Obu-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 11/858,484

(22) Filed: Sep. 20, 2007

(30) Foreign Application Priority Data
Sep. 29, 2006 (JP) 2006-266957

(51) Int. Cl. F16M 13/00

(52) U.S. Cl. 248/560

(57) ABSTRACT

The present invention includes a vibration damping device that has a support for resiliently supporting a fuel pump within a fuel tank via an attaching member. A contact member(s) is disposed between two members that can move relative to each other when the support resiliently deforms, so that the relative movement between two members can be limited by the contact of the contact member with one of the two members.

This application claims priority to Japanese patent application serial number 2006-266957, the contents of which are incorporated herein by reference.

### BACKGROUND OF THE INVENTION

1. Field of the Invention

The present invention relates to devices for damping vibrations of fuel pumps.

2. Description of the Related Art

Japanese Laid-Open Patent Publication No. 2000-240723 teaches a known device for damping vibrations of a fuel pump. FIG. 21 shows a perspective view of the known device. This device includes a pair of damping members 103 interposed between a fuel pump 101 and a sub-tank 102 that accommodates the fuel pump 101 therein. Each damping member 103 includes a plurality of waveform resilient members 131, 133 and 134 for resiliently supporting the fuel pump 101.

With this known device, an effect of damping vibrations (hereinafter called “vibration damping effect”) of the fuel pump 101 can be improved by lowering the rigidity of the resilient members 131, 133 and 134 of each damping member 103. However, unduly lowering the rigidity of the resilient members 131, 133 and 134 may cause brakeage of the resilient members 131, 133 and 134 by a stress that may be produced when an impact force is applied to the fuel pump 101. Therefore, naturally, there is a limitation in lowering the rigidity of the resilient members 131, 133 and 134. For this reason, there has been a problem that it is difficult to improve the effect of damping vibrations of the fuel pump 101

Therefore, there is a need in the art for a vibration damping device that can improve the effect of damping vibrations of a fuel pump and that can prevent or minimize potential breakage of a resilient member.

### SUMMARY OF THE INVENTION

A vibration damping device includes a support that resiliently supports a fuel pump within a fuel tank via an attaching member. The attaching member may be a base for attaching to a fuel tank or may be a reservoir cup disposed within the fuel tank. A contact member(s) is disposed between two members that can move relative to each other in response to the deformation of the support, so that the relative movement between the two members can be limited by the contact of the contact member with one of the two members.

### BRIEF DESCRIPTION OF THE DRAWINGS

FIG. 1 is a front view of a vibration damping device of a fuel pump according to an embodiment of the present invention;

FIG. 2 is a plan view of the vibration damping device shown in FIG. 1;

FIG. 3 is a front view of a vibration damping device of a fuel pump according to another embodiment of the present invention;

FIG. 4 is a plan view of the vibration damping device shown in FIG. 3;

FIG. 5 is a front view of a vibration damping device of a fuel pump according to a further embodiment of the present invention;

FIG. 6 is a plan view of the vibration damping device shown in FIG. 5;

FIG. 7 is a front view of a vibration damping device of a fuel pump according to still further embodiment of the present invention;

FIG. 8 is a plan view of the vibration damping device shown in FIG. 7;

FIG. 9 is a front view of a vibration damping device of a fuel pump according to still further embodiment of the present invention;

FIG. 10 is a plan view of the vibration damping device shown in FIG. 9;

FIG. 11 is a front view of a vibration damping device of a fuel pump according to still further embodiment of the present invention;

FIG. 12 is a plan view of the vibration damping device shown in FIG. 11;

FIG. 13 is a front view of a vibration damping device of a fuel pump according to still further embodiment of the present invention;

FIG. 14 is a plan view of the vibration damping device shown in FIG. 13;

FIG. 15 is a front view of a vibration damping device of a fuel pump according to still further embodiment of the present invention;

FIG. 16 is a plan view of the vibration damping device shown in FIG. 15;

FIG. 17 is a front view of a vibration damping device of a fuel pump according to still further embodiment of the present invention;

FIG. 18 is a plan view of the vibration damping device shown in FIG. 17;

FIG. 19 is a front view of a vibration damping device of a fuel pump according to still further embodiment of the present invention;

FIG. 20 is a plan view of the vibration damping device shown in FIG. 19; and

FIG. 21 is a perspective view of a known vibration damping device.

### DETAILED DESCRIPTION OF THE INVENTION

Each of the additional features and teachings disclosed above and below may be utilized separately or in conjunction with other features and teachings to provide improved vibration damping devices for fuel pumps. Representative examples of the present invention, which utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In one embodiment, a vibration damping device includes a resilient support member for resiliently supporting the fuel pump against the fuel tank and a deformation limiting device for preventing the resilient support member from being deformed by an amount exceeding a predetermined amount.

Therefore, it is possible to improve the effect of damping vibrations of the fuel pump and to prevent or minimize potential breakage of the resilient support member.

In another embodiment, a vibration damping device includes an attaching member for attaching to a fuel tank, a case for accommodating the fuel pump, and a support for resiliently supporting the case against the attaching member. A first member and a second member can move relative to each other in response to the resilient deformation of the support. A contact member(s) is provided on at least one of the first and second members, so that the amount of deformation of the support can be limited by the contact of the contact member with the first member or the second member.

With this arrangement, the rigidity of the support can be reduced to improve the effect of damping vibrations of the fuel pump. In addition, the amount of deformation of the support can be limited within a predetermined amount by the contact member. Therefore, it is possible to improve the effect of damping vibrations of the fuel pump and to prevent or minimize potential breakage of the support.

The contact member can be formed on one of the first and second members. This can simplify the structure of the vibration damping device in comparison with the arrangement where the contact members are formed on both of the first and second members.

One of the first and second members can be the support, and the contact member can be formed on a part of the support. This arrangement enables to form the contact member on the support without substantial increase in rigidity. Therefore, it is possible to avoid potential reduction of the vibration damping effect, which may be caused in the case that the contact member is formed on the support.

The case can be resiliently supported by the support at a position in the vicinity of a gravity center of the fuel pump. With this arrangement, the amplitude of vibrations can be reduced, so that it is possible to reduce a potential stress applied to the support.

In a further embodiment, a vibration damping device includes a pump-side member attached to the fuel pump, a tank-side member attached to a fuel tank, and a resilient member disposed between the pump-side member and the tank-side member. A contact member is disposed between the resilient member and the pump-side member, between the resilient member and the tank-side member, between the resilient member and the fuel pump, or between portions of the resilient member, so that the contact of the contact member with the resilient member, the pump-side member, the tank-side member or the fuel tank can limit the relative movement between the pump-side member and the tank-side member.

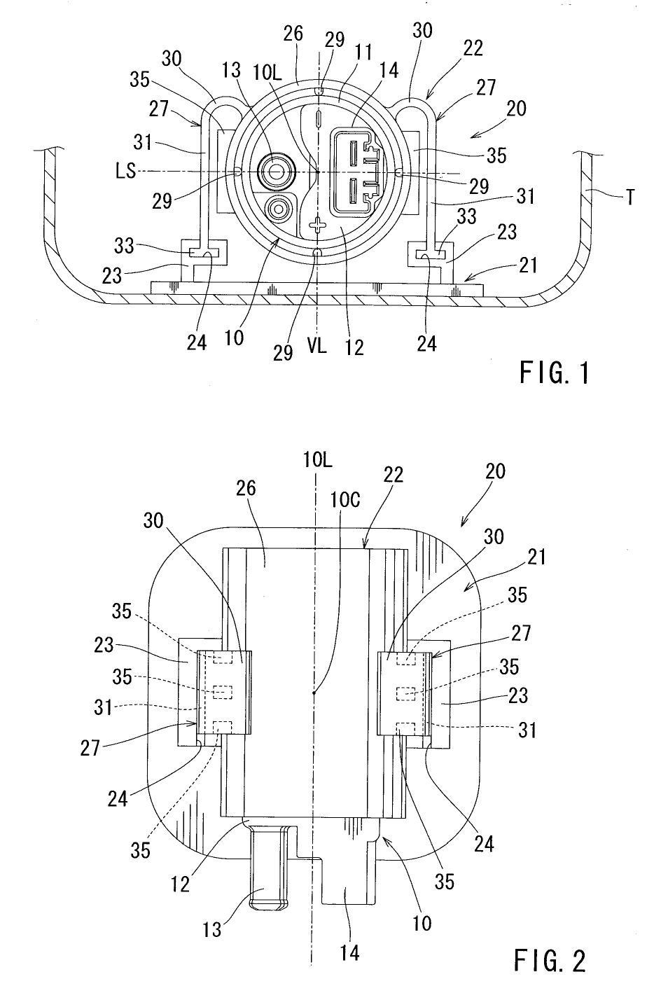

An embodiment of the present invention will now be described with reference to FIGS. 1 and 2. This embodiment relates to a vibration damping device for a fuel pump that is disposed within a fuel tank. The fuel tank can be mounted on a vehicle, such as an automobile. As shown in FIG. 1, a vibration damping device 20 resiliently supports a fuel pump 10 in a horizontal position within a fuel tank T. The term “horizontal position” is used to mean a position where a longitudinal axis 10L of the fuel pump 10 extends horizontally. The fuel pump 10 is of a type called “in-tank and motor-integrated type” and includes an electrically driven motor section and a pump section driven by the motor section (not shown). The fuel pump 10 serves to pump a fuel stored within the fuel tank T in order to supply the fuel to an engine, more specifically, fuel injectors. The fuel pump 10 generally includes a cylindrical pump housing 11 and a motor cover 12 attached to the pump housing 11 for closing an open front end (lower end as viewed in FIG. 2) of the pump housing 11. The motor cover 12 has a fuel discharge port 13 and an electrical connector portion 14. Although not shown in the drawings, the pump section of the fuel pump 10 has a fuel inlet port disposed at the other end (rear end) of the pump housing 11.

Referring to FIG. 1, the vibration damping device 20 includes a base 21 and a support 22. The base 21 may be made of resin. The base 21 has a substantially rectangular plate-like configuration (see FIG. 2). Right and left joint portions 23 are formed integrally with the central portion of the base 21 and are disposed symmetrically with reach other with respect to right and left directions. An engaging recess 24 is formed in each joint portion 23. The engaging recess 24 extends in forward and rearward directions and has an open upper side. More specifically, the engaging recess 24 has a substantially inverted T-shaped cross section. The front side of the engaging recess 24 is opened and the rear side of the engaging recess 24 is closed. The base 21 may be also called as an attaching member for attaching the vibration damping device 20 to the fuel tank T or a reservoir cup as will be described later.

The support 22 may be made of resin and has a substantially cylindrical hollow case 26 and right and left support members 27. The right and left support members 27 are formed respectively integrally with a right upper part and a left upper part of the central portion with respect to the axial direction of the case 26 and are disposed symmetrically with each other respect to the right and left directions. The inner circumferential surface of the case 26 is determined such that the fuel pump 10 can be loosely inserted into the case 26. However, a plurality of retainer projections 29 are formed integrally with the inner circumferential surface of the case 26 at regular intervals in the circumferential direction and extend linearly in forward and rearward directions. In this embodiment, four retainer projections 29 are provided. Therefore, the retainer projections 29 frictionally engage the outer circumference of the pump housing 11 as the pump housing 11 is inserted into the case 26. In other words, the pump housing 11 is press-fitted into the case 26. As a result, the fuel pump 10 can be fixed in position within the case 26.

Each of the support members 27 is formed of a band-like plate that can resiliently deform or is flexible. The support member 27 has a width in the axial direction of the fuel pump 10 (upward and downward directions as viewed in FIG. 2). As shown in FIG. 1, each of the support members 27 has a waveform plate-like part 30 and a flat plate-like part 31 that are integral with each other. The waveform plate-like part 30 extends outwardly along an upwardly convex arc from the corresponding right upper or left upper part of the central portion with respect to the axial direction of the case 26. The flat plate-like part 31 extends linearly downward from the outer end of the waveform-like plate part 30. More specifically, as shown in FIG. 2, the waveform plate-like part 30 is joined to the case 26 at a position radially outward from a gravity center 10C of the fuel pump 10. As shown in FIG. 1. an attaching part 33 extending in forward and rearward directions and having an inverted T-shaped cross section is formed integrally with the lower end of the flat plate-like part 31. Therefore, the support 22 is integrated with the base 21 by inserting the attaching parts 33 of the right and left support members 27 into the corresponding engaging recesses 24 of the base 21 in a direction from the front side toward the rear side of the engaging recesses 24, so that the attaching parts 33 closely engage the engaging recesses 24.

A plurality of contact portions 35 are formed integrally with each of the right and left side surfaces of the case 26 of the support 22. The contact portions 35 oppose to the flat plate-like part 31 of the corresponding support member 27, which is positioned on the outer side of the contact portions 35, and are spaced therefrom by a predetermined distance. Each of the contact portions 35 has a vertical flat plate-like configuration and has an outer end face that is parallel to the flat plate-like part 31 of the corresponding support member 27 when no load is applied to the support member 27. In this embodiment, three contact portions 35 are formed on each of right and left side surfaces of the case 26 and are arranged in the forward and rearward directions at predetermined intervals (see FIG. 2). In addition, each of the contact portions 35 is configured to be symmetrical in upper and lower directions with respect to a horizontal plane LS that is perpendicular to a vertical plane VL extending through the longitudinal axis 10L of the fuel pump 10. The length in the vertical direction of the contact portions 35 can be suitably determined.

Although the vibration damping device 20 supporting the fuel pump 10 as described is positioned within the fuel tank T of the automobile, the vibration damping device 20 can be positioned within a reservoir cup or a sub-tank that may be disposed within the fuel tank T. The base 21 is fixedly attached to the bottom surface of the fuel tank T or the reservoir cup.

As the fuel pump 10 is driven, the fuel pump 10 may vibrate due to rotation of a rotor of the motor section as well as rotation of a rotary member of the pump section. If the vibrations of the fuel pump 10 are transmitted to the fuel tank T or the reservoir cup, noises may be produced.

However, according to this embodiment, the vibrations of the fuel pump 10 may be absorbed or damped by the resilient deformation or the flexing deformation of the support members 27 (more specifically, the waveform plate-like parts 30 and/or the flat plate-like parts 31) of the support 22 of the vibration damping device 20. Therefore, it is possible to prevent or minimize production of potential noises.

Further, when an impact force has been accidentally applied to the fuel pump 10, at least one of the support members 27 (more specifically, the waveform plate-like parts 30 and/or the flat plate-like parts 31), the flat plate-like part 31 of at least one of the support members 27 can contact the contact portions 35. Thus, the flat plate-like part 31 can contact the case 26 via the contact portions 35. Therefore, the amount of possible deformation of the support members 27 can be limited within a predetermined amount. As a result, it is possible to prevent or minimize potential brakeage of the support members 27, because the support members 27 are prevented from being excessively deformed. In this way, the contact portions 35 are provided between the flat plate-like portions 31 of the support members 27 and the case 26 that can move relative to the flat plate-like portions 31 as the support members 27 resiliently deform.

According to the vibration reducing device 20 described above, the rigidity of the support members 27 for supporting the case 26 against the base 21 can be set to be low. Therefore, it is possible to improve the effect of damping vibrations of the fuel pump 10 received within the case 26. In addition, the flat plate-like portions 31 of the support members 27 can move relative to the case 26 and can contact therewith via the contact portions 35. Therefore, the amount of possible deformation of the support members 27 can be limited within a predetermined amount. Therefore, it is possible to improve the vibration damping effect by setting the rigidity of the support members 27 to be low, while it is possible to prevent or minimize potential breakage that may be caused by an accidentally applied impact. Although three contact portions 35 are provided for each support member 27 in the above embodiment, one, two or four or more contact portions 35 can be provided.

In addition, because the contact portions 35 are formed only on the case member 26, the construction can be simplified in comparison with the arrangement where the contact portions 35 are provided also on the flat plate-like portions 31.

Further, because the case 26 is resiliently supported by the support members 27 at positions in the vicinity of the gravity center 10C of the fuel pump 10, it is possible to reduce the amplitude of the vibrations when produced and it is also possible to reduce the potential stress that may be applied to the support members 27.

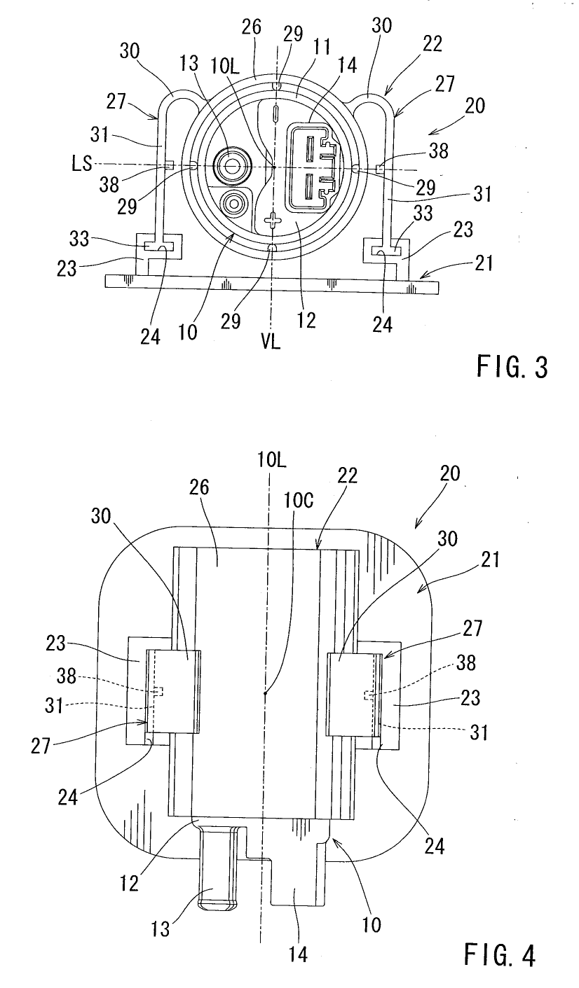

Other possible embodiments will now be described with reference to FIGS. 3 to 20. These embodiments are modifications of the above embodiment. Therefore, like members are given the same reference numeral as FIGS. 1 and 2 and the description of these members will not be repeated.

In the embodiment shown in FIGS. 3 and 4, the contact portions 35 of the above embodiment (see FIGS. 1 and 2) are replaced with contact portions 38 that are formed integrally with the inner surface of the flat plate-like portions 31 of the support members 27 of the support 22. The contact portions 38 are positioned to oppose to the outer surface of the case 26 and are spaced from the outer surface of the case 26 by a predetermined distance. Each contact portion 38 has a rectangular parallelepiped configuration. In this embodiment, only one contact portion 38 is positioned at the central portion of the inner surface of the corresponding flat plate-like portion 31. More specifically, each contact portion 38 extends along an axis (an axis extending within the horizontal plane LS in this embodiment) that is perpendicular to the vertical plane VL from a central position with respect to a widthwise direction (upward and downward directions as viewed in FIG. 4) of the corresponding support member 27.

Also with this embodiment, it is possible to achieve the same advantages as the above embodiment. In particular, because the contact portions 38 are formed partly on the support members 27, it is possible to provide the contact portions 38 without substantial increase in the rigidity of the support members 27. Therefore, it is possible to avoid reduction of the effect of damping vibrations of the fuel pump 10 even if the contact portions 36 are formed on the support members 38. Although only one contact portion 38 is provided on each support member 27 in this embodiment, two or more contact portions 38 may be provided.

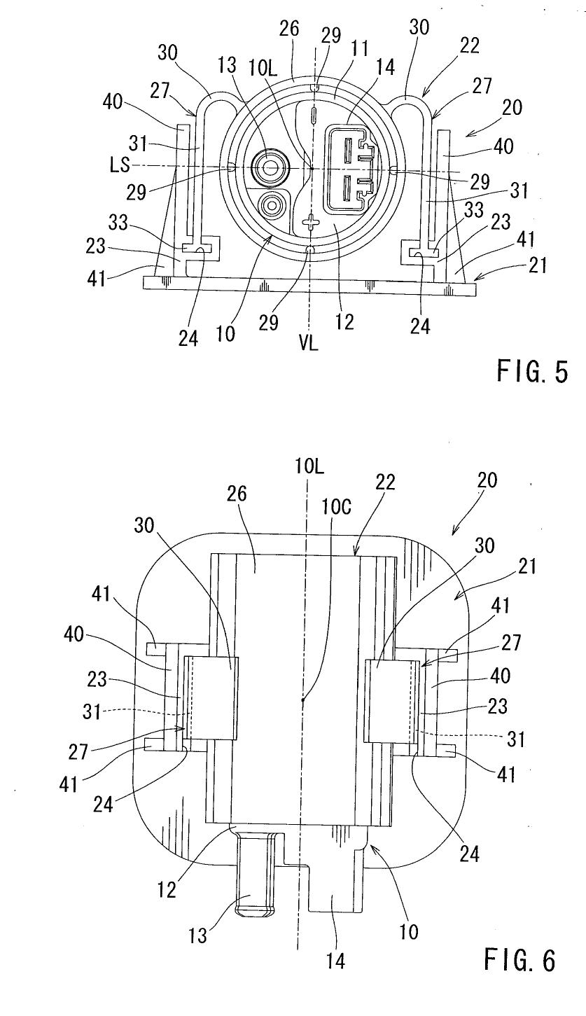

In the embodiment shown in FIGS. 5 and 6, the contact portions 35 of the embodiment of FIGS. 1 and 2 are replaced with contact portions 40 that are formed integrally with the base 21. Each contact portion 40 has an upright plate-like configuration and extends from the upper surface of the base 21 at a position on the outer side of the corresponding joint portion 23. The contact portions 40 are positioned to oppose to the outer surfaces of the corresponding flat plate-like portions 31 that oppose to the outer surface of the case 26. The contact portions 40 are spaced from the outer surfaces of the corresponding flat plate-like portions 31 by a predetermined distance. A pair of front and rear rib portions 41 are formed integrally with each contact portion 40 and also with the base 21 at a corner region defined by the outer side surface of the contact portion 40 and the upper surface of the base 21. In this embodiment, the flat plate-like portions 31 can move relative to the base 21 as the support members 22 resiliently deform. The contact portions 40 can limit the amount of possible deformation of the support member 27 within a predetermined amount when contacting with the corresponding flat plate-like portions 31. As a result, it is possible to achieve the same advantages as the embodiment of FIGS. 1 and 2.

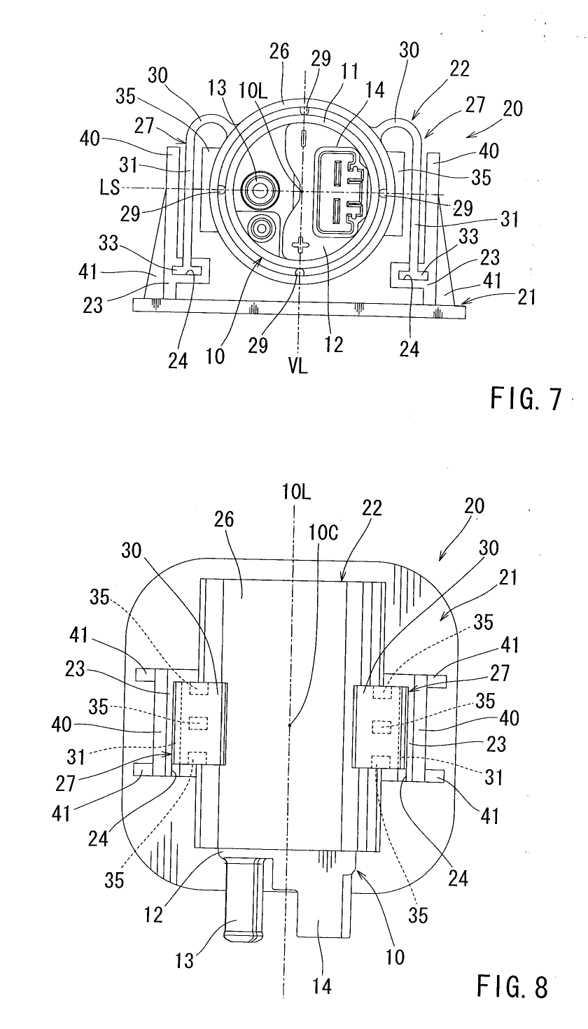

In the embodiment shown in FIGS. 7 and 8, the right and left contact portions 40 similar to the embodiment shown in FIGS. 5 and 6 are added to the base 21 of the vibration damping device 20 of the embodiment shown in FIGS. 1 and 2. Therefore, synergic effects can be achieved by the combination of the embodiment shown in FIGS. 1 and 2 and the embodiment shown in FIGS. 5 and 6.

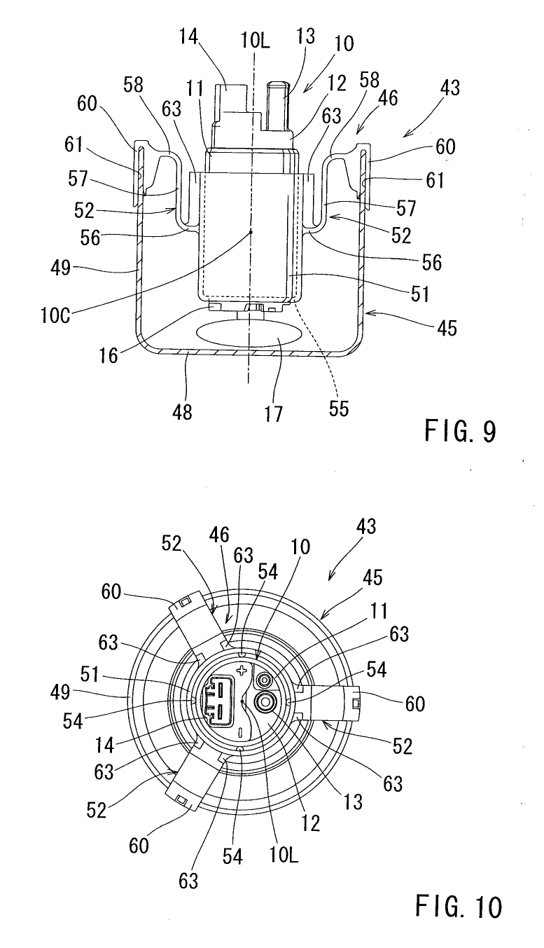

In the embodiment shown in FIGS. 9 and 10, a vibration damping device 43 is configured to resiliently support the fuel pump 10 that is oriented in the vertical direction. More specifically, the longitudinal axis 10L of the fuel pump 10 extends in the vertical direction and the motor cover 12 is positioned on the upper side of the fuel pump 10. In this connection, a fuel inlet port (not shown) is provided on the pump cover 16 that is attached to the pump housing 11 for closing the lower end of the pump housing 11. A suction filter 17 is attached to the pump cover 16 and is in communication with the inlet port. The suction filter 17 serves to filtrate the fuel that is stored within a reservoir cup 45 and is drawn into the fuel pump 10.

The vibration damping device 43 includes a reservoir cup 45 and a support 46. For example, the reservoir cup 45 may be made of resin. The reservoir cup 45 has a bottomed cylindrical tubular configuration and has a bottom plate portion 48 and a side plate portion 49. Therefore, in this embodiment, the reservoir cup 45 corresponds to an attaching member for attaching the vibration damping device 43 to the fuel tank T.

The support 46 also may be made of resin. The support 46 includes a case 51 and three support members 52. The case 51 has a cylindrical tubular configuration and extends in the vertical direction. The three support members 52 are formed integrally with the vertically central portion of the outer circumferential surface of the case 51 and extend radially outward therefrom. Similar to the embodiment shown in FIGS. 1 and 2, the case 51 has a plurality of retainer projections 54 formed integrally with the inner circumferential surface of the case 51 at regular intervals in the circumferential direction. The retainer projections 54 extend linearly in the vertical direction. In this embodiment, four retainer portions 54 are provided on the front, rear, right and left sides as shown in FIG. 9. Therefore, the fuel pump 10 can be fixed in position within the case 51 by press-fitting the pump housing 11 into the case 51 from the upper side. A flange portion 55 is formed on the lower end of the inner circumferential surface of the case 51 in order to support the lower end of the pump housing 11 (see FIG. 9).

Each support member 52 has a band-like configuration with a width in the circumferential direction of the fuel pump 10 (see FIG. 10) and is resiliently deformable or flexible. As shown in FIG. 9, each support member 52 has a case-side waveform plate-like portion 56, a flat plate-like portion 57 and a cup-side waveform plate-like portion 58 that are formed integrally with each other. The case-side waveform plate-like portion 56 warps upward and extends radially outward from the middle portion with respect to the vertical direction of the outer circumferential surface of the case 51. The flat plate-like portion 57 extends linearly upward from the outer end of the case-side waveform plate-like portion 56. The cup-side waveform plate-like portion 58 warps upward and extends radially outward from the upper end of the flat plate-like portion 57. Naturally, the case-side waveform plate-like portion 56 is connected to the case 5la at a position radially outward from a gravity center 10C of the fuel pump 10 that is supported within the case 51. A mount portion 60 is formed integrally with the radially outer end of the cup-side waveform plate-like portion 56 and has a latching recess 61 that can latch the upper end of the side plate portion 49 of the reservoir cup 45. Therefore, each of the support members 52 is integrated with the reservoir cup 45 by closely fitting the latching recess 61 of the mount portion 60 with the upper end of the side plate portion 49.

Contact portions 63 are formed integrally with the upper portion of the outer circumferential surface of the case 51. The contact portions 63 are positioned to oppose to the flat plate-like portions 57 of the support members 52 and are spaced therefrom by a predetermined distance. Each of the contact portions 63 has a vertically extending flat plate-like configuration and has a radially outer edge that extends parallel to the flat plate-like portion 57 of the corresponding support member 52 when no load is applied to that support member 52. In this embodiment, two contact portions 63 are provided for each support member 52 and are correspondingly arranged in the widthwise direction of each support member 52 (see FIG. 10). In addition, each contact portion 63 is connected to the upper side of the case-side waveform plate-like portion 56 of the corresponding support member 52. Further, each contact portion 63 has an upper end positioned at substantially the same level as the upper end face of the case 51 (see FIG. 9). The vertical length of the contact portions 63 can be suitably changed.

The vibration damping device 43 supporting the fuel pump 10 can be disposed within the fuel tank T (not shown in FIGS. 9 and 10). The reservoir cup 45 can positioned within the fuel tank T and can be fixedly attached to the bottom of the fuel tank T.

When the fuel pump 10 is driven, the fuel pump 10 may vibrate due to the rotation of the rotor of the motor section and the rotary member of the pump section. Therefore, noises may be produced when the vibrations are transmitted to the fuel tank T via the reservoir cup 45.

However, according to the above embodiment, the vibrations of the fuel pump 10 can be absorbed or damped by the resilient deformation or the flexing deformation of the support members 52 (more specifically, the case-side waveform plate-like portions 56 and/or flat plate-like portions 57 and/or cup-side waveform plate-like portions 58) of the support 46 of the vibration damping device 43, which resiliently support the fuel pump 10. Therefore, it is possible to prevent or minimize generation of noises.

Even in the event that an impact force has been applied to the fuel pump 10, none of the support members 52 (more specifically, the case-side waveform plate-like portions 56 and/or flat plate-like portions 57 and/or cup-side waveform plate-like portions 58) does not cause excessive flexing deformation.

Thus, according to this embodiment, when an impact force is applied to the fuel pump 10, the flat plate-like portion 57 of at least one of the support members 52 can contact the corresponding contact portions 63. In other words, the flat plate-like portion 57 can contact the case 51 via the contact portions 63. Therefore, the amount of deformation of the support member(s) 52 can be limited within a predetermined amount. For this reason, it is possible to prevent or minimize potential breakage of the support members 52 due to their excessive flexing deformation.

With the vibration damping device 43 of the fuel pump 10 according to the above embodiment, the effect of damping vibrations of the fuel pump 10 disposed within the case 51 can be improved by the reduction of rigidity of the support members 52 that resiliently support the case 51 against the reservoir cup 45. In addition, because the flat plate-like portions 57 of the support members 52 can contact the case 51 via the contact portions 63, the amount of deformation of the support members 52 can be limited within a predetermined amount. Therefore, it is possible to prevent or minimize potential breakage of the support members 52, which may be caused by an impact force, while it is possible to improve the vibration damping effect by the reduction in rigidity of the support members 52. Although two contact portions 63 are provided for each support members 52 in the above embodiment, one or three or more contact portions 63 can be provided. In addition, the number of the support members 62 can be suitably reduced or increased.

Further, in this embodiment, the contact portions 63 are formed only on the case 51. Therefore, in comparison with the arrangement where the contact portions 63 are formed on both of the case 51 and the flat plate-like portion 57 of each support member 52, the construction can be simplified.

Furthermore, because the case 51 is resiliently supported by the support members 52 at positions in the vicinity of the gravity center 10C of the fuel pump 10, the amplitude of potential vibrations can be reduced and potential stresses applied to the support members 52 can be reduced.

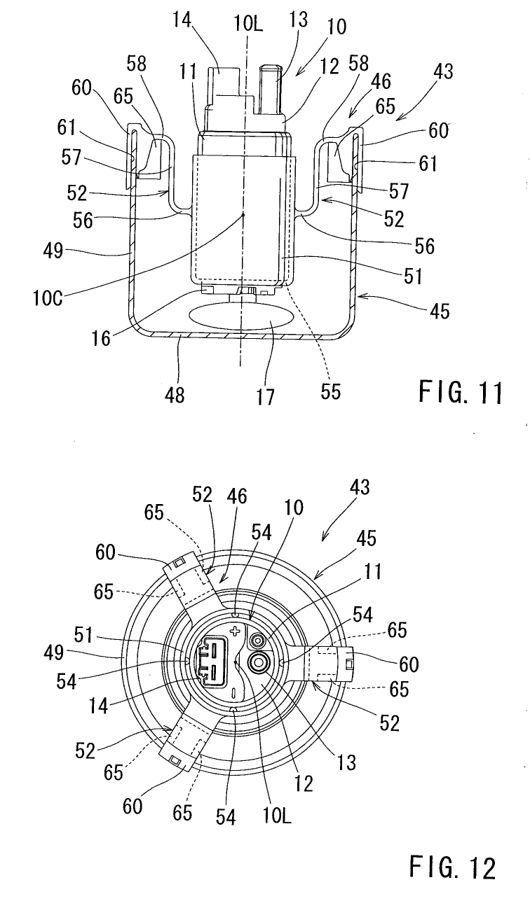

In an embodiment shown in FIGS. 11 and 12, contact portions 63 of the above embodiment shown in FIGS. 9 and 10 are replaced with contact portions 65 shown in FIG. 11. The contact portions 65 are formed integrally with the radially inner face of the mount portion 60 of each support member 52 and oppose to the corresponding flat plate-like portion 57 such that the contact portions 65 are spaced from the corresponding flat plate-like portion 57 by a predetermined distance. Each contact portion 63 has a vertically extending flat plate-like configuration and has an inner end face that extends parallel to the corresponding flat plate-like portion 57 when no load is applied to the flat plate-like portion 57. In addition, each contact portion 63 is connected to the radially outer side part of the cup-side waveform plate-like portion 58 and has a lower end face positioned at substantially the same level as the lower end of the radially inner side face of the corresponding mount portion 60. In this embodiment, two contact portions 65 are provided on each support member 52 and are correspondingly arranged in the widthwise direction of each support member 52 (see FIG. 12).

Also with this embodiment, it is possible to achieve the same advantages as the embodiment of FIGS. 9 and 10. The vertical length of the contact portions 65 can be suitably changed. In addition, one or three or more contact portions 65 can be provided on each support member 52.

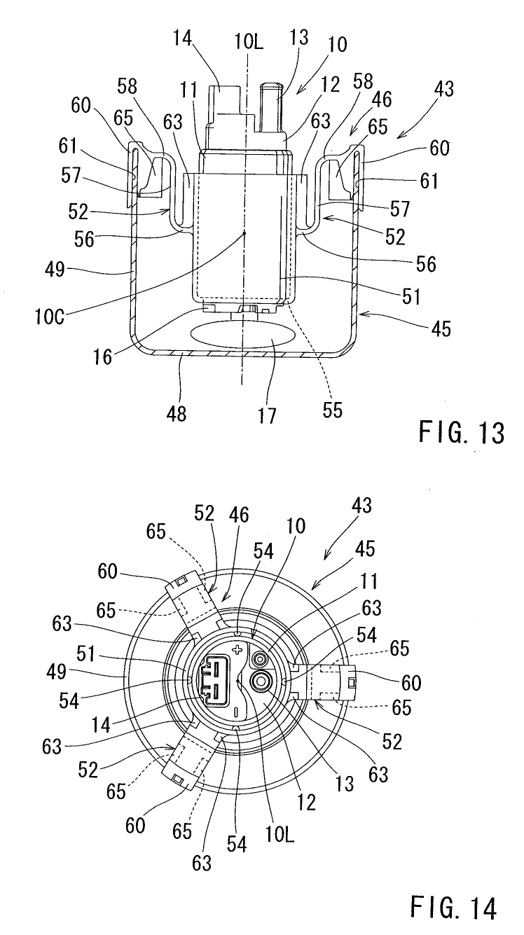

An embodiment shown in FIGS. 13 and 14 corresponds to the embodiment shown in FIGS. 9 and 10 but additionally includes the contact portions 65 of the embodiment of FIGS. 11 and 12. Thus, the contact portions 65 are provided on the support members 52 of the support 46. Therefore, with this embodiment, a synergic effect by the combination of the embodiment of FIGS. 9 and 10 and the embodiment of FIGS. 11 and 12 can be achieved.

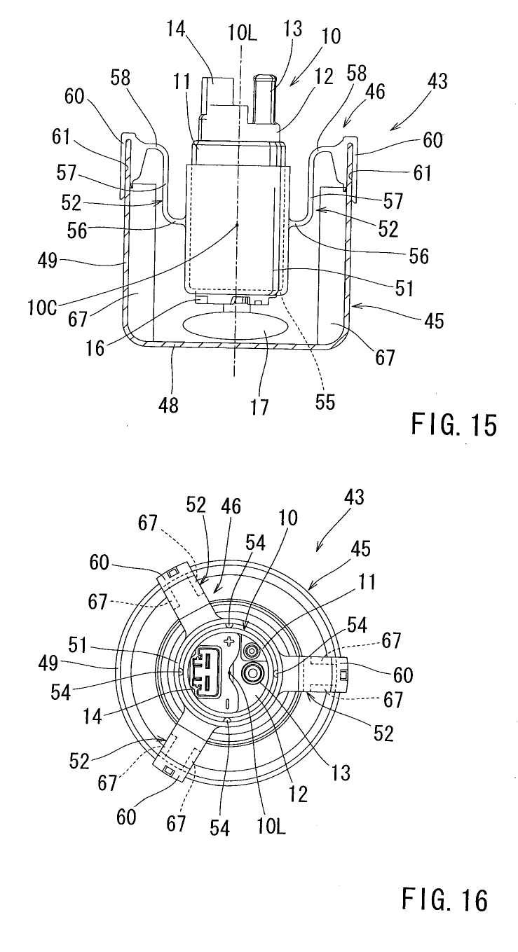

In an embodiment shown in FIGS. 15 and 16, the contact portions 65 of the embodiment of FIGS. 11 and 12 are replaced with contact portions 67. The contact portions 67 are formed integrally with the radially inner side face of the side plate portion 49 of the reservoir cup 45 and oppose to the corresponding flat plate-like portion 57 such that the contact portions 67 are spaced from the corresponding flat plate-like portion 57 by a predetermined distance. Each contact portion 67 has a vertically extending flat plate-like configuration and has an inner end face that extends parallel to the corresponding flat plate-like portion 57 when no load is applied to that flat plate-like portion 57. In this embodiment, two contact portions 67 are provided for each support member 52 and are correspondingly arranged in the widthwise direction of each support member 52. In addition, the lower end of each contact portion 67 is connected to the bottom plate 48 of the reservoir cup 45 and the upper end of each contact portion 67 is positioned to contact with or proximally to the radially inner face of the mount portion 60.

Also with this embodiment, it is possible to achieve the same advantages as the embodiment of FIGS. 11 and 12. The vertical length of the contact portions 67 can be suitably changed. In addition, one or three or more contact portions 67 can be provided on each support member 52.

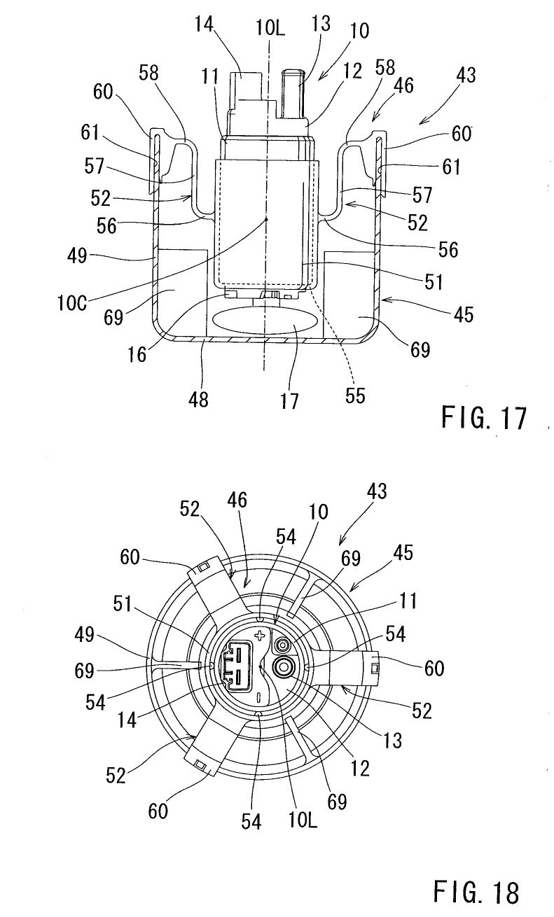

In an embodiment shown in FIGS. 17 and 18, the contact portions 67 of the embodiment of FIGS. 15 and 16 are replaced with contact portions 69. The contact portions 69 oppose to the lower part of the case 51 of the support 46 and are spaced therefrom by a predetermined distance. In this connection, the contact portions 69 extend radially inward than the contact portions 67. In addition, the upper end of each contact portion 69 is positioned at a lower level than the contact portions 67 so as to directly oppose to the lower part of outer circumferential face of the case 51. In this embodiment, three contact portions 69 are provided and are angularly offset from the support members 52 of the support 46 by half the angle of between the support members 52 (see FIG. 18).

Therefore, also with this embodiment, it is possible to achieve the same advantages as the embodiment of FIGS. 9 and 10. In addition, because the contact portions 69 are offset from the support members 52 of the support 46 by half the angle of between the support members 52, it is possible to extend the upper ends of the contact portions 69 further upward. However, the positioning of the upper end of each contact portion 69 at a lower level to oppose to the lower part of outer circumferential face of the case 51 allows the contact portions 69 to be positioned at any angular position regardless of the angular positions of the support members 52 of the support 46.

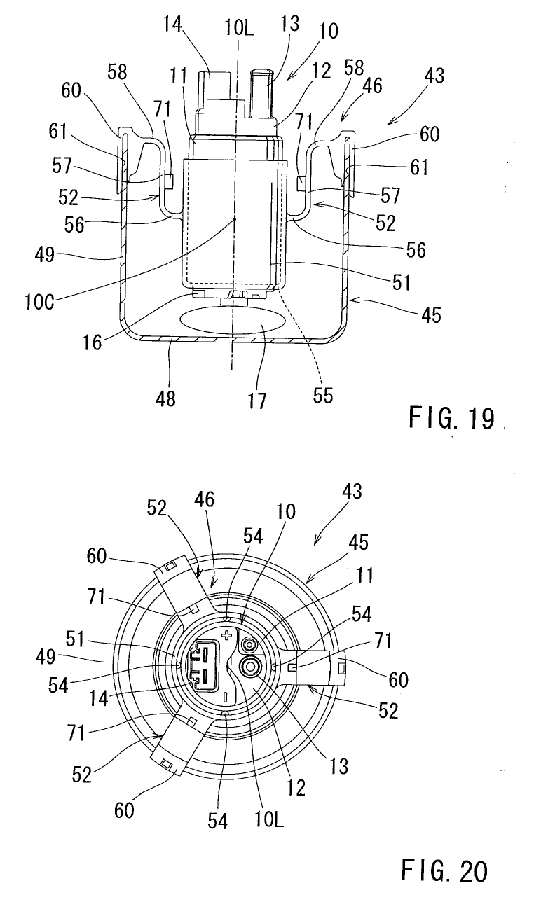

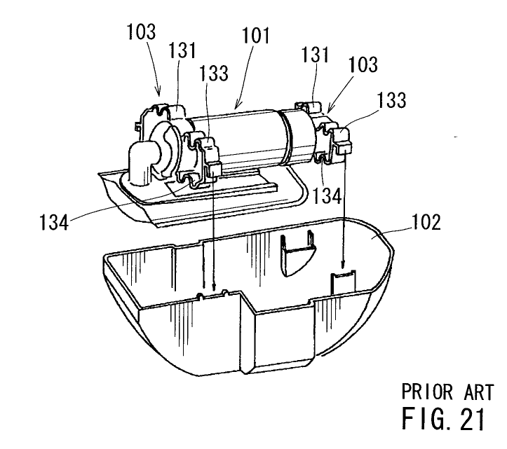

In an embodiment shown in FIGS. 19 and 20, the contact portions 63 of the embodiment shown in FIGS. 9 and 10 are replaced with contact portions 71. The contact portions 71 are formed integrally with radially inner sides of the flat plate-like portions 57 of the support members 52 of the support 46. The contact portions 71 oppose to the outer circumferential face of the case 51 of the support 46 and are spaced therefrom by a predetermined distance. In this embodiment each of the contact portions 71 has a rectangular parallelepiped configuration. In addition, a single number of the contact portion 71 is provided on the central part with respect to the widthwise direction of the flat-plate portion 57 of each support member 52 (see FIG. 20).

Also with this embodiment, it is possible to achieve the same advantages as the embodiment of FIGS. 9 and 10. In addition, each contact portion 71 is formed on a part of each support member 52. Therefore, it is possible to provide the contact portions 71 on the support members 52 without substantial increase in the rigidity of the support members 52. As a result, it is possible to minimize potential reduction of the vibration damping effect although the contact portions 71 are provided. Although a single number of the contact portion 71 is provided on each support member 52 in this embodiment, two or more contact portions 71 can be provided.

The prevent invention may not be limited to the present invention but may be modified in various ways. For example, the base (i.e., the attaching member) and the support are formed separately from each other in the above embodiments, these members can be formed integrally with each other. In addition, the configuration of the base as well as the structure for joining the base to the support can be suitably changed. Further, the configurations, the number and the set positions of the support members can be suitably changed. Further, the contact portions can be provided also on the member with which the contact portions contact. Furthermore, the contact portions that are spaced from the outer circumferential face of the case may directly oppose to the outer circumferential face of the pump housing 11 of the fuel pump 10. In such an embodiment, windows may be formed in the case in positions opposing to the contact portions in order to permit passage of the contact portions for contacting with the pump housing 11.

This invention claims:

1. A vibration damping device for damping vibrations of a fuel pump mounted to a fuel tank, comprising:
an attaching member constructed to be attached to the fuel tank;
a case constructed to accommodate the fuel pump;
a support constructed to resiliently support the case against the attaching member; and
a first member and a second member that can move relative to each other in response to the resilient deformation of the support; and
a contact member provided on at least one of the first and second members, so that the amount of deformation of the support can be limited by the contact of the contact member with the first member or the second member.

2. The vibration damping device as in claim 1, wherein the contact member is formed on one of the first and second members.

3. The vibration damping device as in claim 1, wherein one of the first and second members comprises the support, and wherein the contact member is formed on a part of the support.

4. The vibration damping device as in claim 1, wherein the case member is resiliently supported by the support at a position in the vicinity of a gravity center of the fuel pump.

5. A vibration damping device for damping vibrations of a fuel pump disposed within a fuel tank, comprising:
a pump-side member attached to the fuel pump;
a tank-side member attached to the fuel tank;
a resilient member disposed between the pump-side member and the tank-side member;
a contact member disposed between the resilient member and the pump-side member, between the resilient member and the tank-side member, between the resilient member and the fuel pump, or between portions of the resilient member, so that the contact of the contact member with the resilient member, the pump-side member, the tank-side member or the fuel pump can limit the relative movement between the pump-side member and the tank-side member.

6. The vibration damping device as in claim 5, wherein the contact member is provided on one of the resilient member and the pump-side member, so that the contact member can contact the other of the resilient member and the pump-side member.

7. The vibration damping device as in claim 6, wherein the contact member is spaced from the other of the resilient member and the pump-side member by a predetermined distance in a radial direction with respect to a central axis of the fuel pump when no load is applied to the resilient member.

8. The vibration damping device as in claim 5, wherein the contact member is provided on one of the resilient member and the tank-side member, so that the contact member can contact the other of the resilient member and the tank-side member.

9. The vibration damping device as in claim 8, wherein the contact member is spaced from the other of the resilient member and the tank-side member by a predetermined distance in a radial direction with respect to a central axis of the fuel pump when no load is applied to the resilient member.

10. The vibration damping device as in claim 5, wherein the contact member is provided on one of the resilient member and the fuel pump, so that the contact member can contact with the other of the resilient member and the fuel pump.

11. The vibration damping device as in claim 10, wherein the contact member is spaced from the other of the resilient member and the fuel pump by a predetermined distance in a radial direction with respect to a central axis of the fuel pump when no load is applied to the resilient member.

12. The vibration damping device as in claim 5, wherein the contact member is provided on one of the portions of the resilient member, so that the contact member can contact with the other of the portions of the resilient member.

13. The vibration damping device as in claim 12, wherein the contact member is spaced from the other of the portions of the resilient member by a predetermined distance in a radial direction with respect to a central axis of the fuel pump when no load is applied to the resilient member.

14. The vibration damping device as in claim 5, wherein the pump-side member comprises a case for accommodating the fuel pump.

15. The vibration damping device as in claim 5, wherein the tank-side member comprises a base constructed to be fixedly attached to the fuel tank.

16. The vibration damping device as in claim 5, wherein the tank-side member comprises a reservoir cup disposed at the bottom of the fuel tank.

17. A vibration damping device for damping vibrations of a fuel pump disposed within a fuel tank, comprising:
a resilient support member constructed to resiliently support the fuel pump against the fuel tank; and
deformation limiting device for preventing the resilient support member from being deformed by an amount exceeding a predetermined amount.

18. The vibration damping device as in claim 17, wherein the deformation preventing device comprises a first member and a second member that can move relative to each other in response to deformation of the resilient support member, wherein at least one of the first and second members comprises a contact member for contacting with the first member or the second member.
